(19) United States
(12) Patent Application Publication
(10) Pub. No.: US 2014/0268328 A1
(43) Pub. Date: Sep. 18, 2014

(54) Polarization Grating Stack

(71) Applicant: Raytheon Company, Waltham, MA (US)

(72) Inventors: Terry A. Dorschner, Marlborough, MA (US); Irl W. Smith, Concord, MA (US)

(21) Appl. No.: 13/801,411

(22) Filed: Mar. 13, 2013

(51) Int. Cl. G02F 1/29; G02B 5/30

(52) U.S. Cl. CPC G02F 1/292; G02B 5/3041
USPC 359/484.01; 359/485.04

(57) ABSTRACT

A stack of polarization gratings each having a grating pitch, the stack having a first end and a second end and, the polarization grating stack including N stages wherein one or more of the N stages in the stack comprise a first set of gratings which direct an incident beam through angles lying substantially in a first plane and one or more of the N stages in the stack comprise a second set of gratings which direct an incident beam through angles lying substantially in a second, different, plane lying at an angle relative to the first plane and wherein each of the N stages provide one of a plurality of deflection angles and wherein the N stages are arranged such that a stage having the smallest deflection angle is nearest the first end of the stack and a stage having the largest deflection angle is nearest the second end of the stack and wherein the deflection angles of the gratings in each set are chosen such that the grating pitch of each grating is at least one of: substantially twice the grating pitch of another member of the set; or substantially one-half the grating pitch of another member of the set.

### CROSS REFERENCE TO RELATED APPLICATIONS

This application is a continuation of co-pending application of U.S. application Ser. No. 13/250,111, filed Sep. 30, 2011, which claims the benefit of U.S. Provisional Application No. 61/389,015, filed Oct. 1, 2010, which applications are hereby incorporated by reference in their entireties.

### FIELD OF THE INVENTION

The system and techniques described herein relate generally to optical phased arrays and more particularly to steering a beam of an optical phased array.

### BACKGROUND OF THE INVENTION

As is known in the art, there is a desire to provide an optical system capable of transmitting, receiving, and rapidly steering spatially phased optical energy and images, such a system having a composite aperture comprising multiple individual apertures (i.e., the composite aperture is an array of apertures) each of each should be transmissive.

One such system which includes an array of small phase-locked apertures with adaptive correction of phase distortions incorporated directly into each aperture, is referred to as an Adaptive Photonics Phase-Locked Elements (APPLE). In the APPLE system, a conventional high-resolution adaptive optics (AO) system is replaced by an array of low-resolution “local” AO sub-systems (distributed AO) operating in parallel.

The APPLE system thus includes an array of apertures capable of transmitting and rapidly steering spatially phased optical energy and images in which each aperture should be transmissive.

In some applications, it is desirable for a system such as the APPLE system to have the ability to continuously slew at about 3-5 deg/sec (it should be noted that the term ‘scan’ may be considered more conventional than the term ‘slew’). Existing current optical phased arrays (OPAs), with a switching time of approximately 2 ms, can scan (with slew losses of 1-2 dB) at only 0.5-1 deg/sec. Faster slewing results in higher slew loss levels which may be unacceptable in some applications.

It has been recognized that a combination of OPAs and mechanical steering can increase slew rates over that available with OPAs alone while maintaining the precision and agility of the OPAs and most of the speed of the mechanical steering.

It would, however, be desirable to provide to an optical phased array which can continuously slew at rate in the range of about 3-5 deg/sec. or higher with high throughput.

### SUMMARY OF THE INVENTION

Described herein is a stack of polarization gratings each having a grating pitch, the stack having a first end and a second end and, the polarization grating stack including N stages wherein one or more of the N stages in the stack comprise a first set of gratings which direct an incident beam through angles lying substantially in a first plane and one or more of the N stages in the stack comprise a second set of gratings which direct an incident beam through angles lying substantially in a second, different, plane lying at an angle relative to the first plane and wherein each of the N stages provide one of a plurality of deflection angles and wherein the N stages are arranged such that a stage having the smallest deflection angle is nearest the first end of the stack and a stage having the largest deflection angle is nearest the second end of the stack and wherein the deflection angles of the gratings in each set are chosen such that the grating pitch of each grating is at least one of: substantially twice the grating pitch of another member of the set; or substantially one-half the grating pitch of another member of the set.

Also described herein as an additional element is a stack of polarization gratings, each controlled by a liquid-crystal wave plate which may be used in the APPLE system.

Also described herein is the use of a fast-scanning optical phase array (OPA) within an electronic beam-steering-based aperture suitable for use in a system such as the Adaptive Photonically Phase-Locked Elements (APPLE) system, for example.

It has been recognized that slew rates above the range of about 3-5 deg/sec. can possibly be met using a mechanical (Risley) slewing mechanism or a faster optical phased arrays (OPA). Such slew rates are desirable in a system such as the APPLE system.

It has also been recognized that to provide a faster OPA, the only viable path appears to be the introduction of dual-frequency liquid crystals (DFLC), for which full-wave switching times of approximately 200 microseconds have been measured. An OPA with such a switching time would support slewing at about 5-10 deg/sec. DFLC switching at those speeds, however, are obtained with the application of 200V driving signals. Also, it is believed that such voltage levels are not compatible with high density integrated circuits and thus use of 200V driving signals is currently considered impractical for an OPA for which thousands of electrodes typically must be addressed. While it is considered feasible to develop DFLCs with lower driving voltages, such DFCLs, however, do not yet exist in a usable form.

It has also been recognized that it is practical to build a DFLC adaptive optic (AO). An AO typically has far fewer electrodes than does an OPA, need not use voltage-limited addressing application specific integrated circuits (ASICs), and can therefore be driven with higher voltage. For example, one embodiment of an APPLE AO has only 127 pixels (electrodes) compared to thousands for the OPAs. One AO design used in the APPLE system provides an example of direct connection of each of the 127 AO pixels to a separate leadout conductor. Driving such a design with perhaps as high as 200V signals appears to be practical, and represents a path to a very fast DFLC AO, using currently available DFLC material.

The presumed practicality of such a DFLC AO implies that an OPA with a similarly low electrode count would also be practical. Such an OPA would have a very limited steering range. However, it has been recognized that saccade operation provides a means to use an OPA with a small angular range but high speed to provide on optical system such as an APPLE system with a relatively high speed slewing.

The concept of using a combination of OPAs and mechanical steering was analyzed and modeled and next provided is a description of how such a hybrid slewing system works.

One existing APPLE system uses a fiber feed in the focal plane of a beam expanding collimator wherein a piezo (PZT) actuator provides a small amount of transverse motion of the fiber tip (of order ±100 microns). This motion is transformed to small angular motions of the collimated output beam (of order ±50 micro-radians, depending on the effective focal length of the collimator). This function provides rapid tip/tilt correction for adaptive optics in the existing APPLE system. It was recognized that that same PZT actuator can also be used to provide slewing of the output beam, albeit only over small angles. However, when the PZT actuator comes to the end of its range, it can be reset to the opposite end of its dynamic range, a second ‘conventional’ OPA simultaneously re-steered to compensate for the PZT reset, and the slewing continued, resulting in an angularly continuous (but temporally modulated) slew over the entire APPLE field of regard (FoR). With this operating scheme the OPAs need only be updated once every time the PZT actuator is scanned over its full dynamic range, rather than once or more for every incremental spot motion, and this results in a higher net slew rate than the OPAs can provide on their own. This operating mode is referred to as “saccadic” operation.

In one embodiment of an APPLE system, a PZT fiber actuator of provides only about ±2 spots motion and does so only at a 1.5 kHz bandwidth. Prospects for increasing either the angular motion or the speed are considered unlikely for high-power array designs, whereas increases in both are needed to profit from saccade operation and obtain the desired slew rates.

It has been found, however, that a small-angle fast-steering OPA (FSOPA) can be developed to perform this function. It is desirable for the FSOPA to have as large a steering range as possible because that reduces frequency of regular (slow) OPA resets and therefore results in higher net slew rates. However, the larger the FoR, the more OPA electrodes are needed, and there is a (as yet unknown) limit to how many electrodes can be driven at high voltages in a given package size (e.g. a sized compatible with an APPLEt diameter), but it is believed that an electrode count on the order of at least 100 should be acceptable.

In one embodiment, (e.g. a Phase 2 APPLEt), the OPAs and AOs are located within the collimator, where the beam is about one-half the output beam diameter (i.e. the device should have a clear aperture of about 13 mm). Thus, in one FSOPA embodiment, an angular motion of ±10 spots with a steering efficiency of about 97% (implying approximately 10 phase steps per phase ramp), which requires 100 electrodes is considered. This means the electrodes have a 130 micron pitch and the device would have a 20 spot field of regard (FoR).

This compares to about a 5 spot FoR for a conventional PZT actuator.

A control scheme for DFLC devices has been demonstrated which supports continual phase changes at about a 4 kHz update rate, and extension to near 10 kHz appears feasible. In this mode, the device moves linearly from one phase state, at the start of an update period, to a second one, at the end of the period. One scan-loss model is approximately applicable to this case, with an effective time constant of the update period (e.g., 250 μs at 4 kHz) divided by 1.8. This scan-loss model states that the scan loss is 1 dB at a scan rate of 0.25 times the wavelength divided by the aperture diameter per response time constant, here 140 μs. Thus, the slew rate in object space for a 1 dB loss would be 0.076 radian (4.4°) per second. This loss scales linearly with slew rate. At 4.4 degrees per second, the 20 spot (840 microradian) saccade period comes out to be 11 ms. The blocking time, when the conventional OPA resets, is about 2 ms, so the additional loss averaged over this interval is also about 1 dB. The point design appears to adequately address the problem. Systems simulations are expected to result in a somewhat more optimal FSOPA design.

It should be noted that Saccade operation impacts system performance in a number of ways, two of which are discussed below.

When the FSOPA reaches the edge of its 20-spot FoR, it resets, and the ‘standard’ larger-angle OPA is updated to compensate for the angular change of 20 spots. Kalman estimators can be used to predict where the target should have moved to during the reset so that when the update is made the beam can be put back on the target. The shorter the reset time, the better the assumption that the target hasn't changed course beyond the expected Kalman uncertainty. For the current 2 ms reset time this seems to be a reasonable expectation for motions along the target down-range trajectory. Whether the target is likely to move (or through platform jitter appear to move) more than one spot cross-range in 2 ms needs to be considered.

The resets of the saccade operation effectively reduce power on the target. For an array of APPLEts, the reset losses can be mitigated by programming the resets to occur at different times for the different APPLEts. The degree of mitigation depends upon the length of the reset time compared to the length of the saccade scan

Both of these saccade drawbacks can be mitigated with faster reset OPAs. It appears that the coarse OPAs which support the resets will have a pinout substantially less than 100, so these devices are also candidates for use of DFLC. In that case the dead time during a saccade is simply one update interval

Development of an FSOPA steering system also enables elimination of the aforementioned PZT fiber actuator in existing APPLE systems. The FSOPA would be faster (by almost an order of magnitude) and have a 4-fold larger angular range than does the current PZT fiber actuator used in the APPLE system. It can do the same job as the PZT actuator, namely, tip/tilt correction for the adaptive optics, but do it faster, and it can simultaneously support the fast slewing required.

Accordingly, an array of phase-locked sub-apertures with adaptive correction of phase distortions incorporated directly into each sub-aperture (such as an APPLE system) will perform better with FSOPAs replacing a PZT fiber actuator (it should be noted that one FSOPA is needed for each dimension.)

Replacement of the PZT fiber actuator with a FSOPA eliminates mechanical motion in the APPLE system, resulting in a true non-mechanical, all-electronic system, and a much more robust system. The FSOPA will be at least as robust as a conventional OPA, which from tests is operable to hundreds of g's.

Furthermore, one possible issue with the current APPLE system is the demonstrated presence of higher order modes in the over-moded delivery fiber. These modes move around within the fiber core when the fiber is bent, change relative phases, and cause the output beam to both deform and move about, and that motion appears to preclude meeting the pointing accuracies desired. Replacement of the PZT fiber actuator with an FSOPA means that the fiber no longer needs to move and can be firmly anchored, presumably significantly reducing mode motions.

A fixed feed-point also allows the APPLE system to be fed by free-space lasers; thus, APPLE-type systems will no longer restricted to fiber lasers. Although fiber lasers are preferred in one sense because of their higher efficiencies, other laser types do offer other potential advantages, and new APPLE designs will allow tradeoffs to be made. As one example, a so-called Semi-Guiding High Aspect Ratio Core (SHARC) laser under development at Raytheon Space and Airborne Systems (SAS), El Segundo, Calif. 90245, USA offers an alternate path to mitigation of stimulated Brillioun scatter (SBS) because the effective core size is much larger than even the over-moded 25 micron core fibers currently used in APPLE. If the current SBS mitigation approach taken by RIFL (phase modulation at several GHz) proves to be incompatible with the APPLE control systems, SHARC offers a ready solution. It is compact and relatively high efficiency (25% wall plug efficiency predicted). It also offers prospects of operating at higher output powers (10 kW) than is predicted for single-mode fiber lasers (3-5 kW), meaning that the per sub-aperture power of an APPLE system would be limited by the damage levels of the APPLEt components rather than the fiber lasers. It is believed to be desirable to use as high power as possible per subaperture in order to reduce (or ideally minimize) the number of APPLEts needed to scale an array to desired power levels. The SHARC laser offers that prospect, and the APPLE architecture described herein makes the use of a SHARC laser feasible.

It has also been recognized that wide-angle electronic beamsteering systems requiring use of multiple apertures are useful for high-power directed-energy weapon (DEW) applications. For these systems, high fill factor, high throughput, and high scan speed are all needed. Here “fill factor” refers to the fraction of the face area of the composite aperture which is actually within the emitting areas of the individual apertures as opposed to non-emitting areas given over to support structure. High areal fill factor is important for maintaining a compact and high-efficiency beam on the distant target and is directly enabled by the architecture disclosed herein.

In accordance with the present invention, elimination of areal overhead of zone-fill OPAs at the exit aperture can be achieved by moving them internally where the beam is smaller and there is room around it for the overhead. Also, polarization gratings (PGs), electrically controlled rather than angle-addressed can be used to allow transmission of steerable beams through them. Also at least one very fast, dual-frequency liquid-crystal- (DFLC-) based, OPA pair can be implemented for fast scanning.

DFLC-based OPAs have been conceptualized, but the voltage requirements were thought to require a new, expensive, development for onboard control ASICs. Described herein, however, is a DFLC OPA having very small angle range, which may be controlled offboard with reasonable pinout. Also, use of OPAs in diverging beams has been thought to be difficult. However, in accordance with the present invention, these elements are combined with PGs in a non-obvious well-optimized system concept.

This is one important factor in improving device efficiency and ability to scan fast enough to meet desired scan rates (also referred to herein as slew rates).

In accordance with a further aspect of the present invention, an aperture is provided having five stages, each comprising a switchable half-wave plate (SHWP) followed by a single passive polarization grating (PG), with deflections S of approximately 1°, 2°, 4°, 8°, and 16°. This structure supports a field of regard (FoR) of ±31° with 2° resolution (the zero-deflection state is unavailable).

For example, by selecting −S on all the PGs except the 16° one, the system provides an angle of one degree (1°). The next available angle, +3°, is {+1°, −2°, −4°, −8°, +16°}. Thus, for the passive-PG case, the described approach requires roughly one-half as many PGs for the same resolution as proposed in the above-described prior art approach.

Turning now to the active-PG case, if deflections of 1°, 3°, 9° and 27° are used, it is possible to cover ±40° with the same number of PGs used in prior art approaches to cover about ±30° and the approach of the present invention also provides an improved resolution of 1°. It is possible to get +40° by setting all PGs to +S. It is possible to get 1° by zeroing all PGs except the first (i.e., applying voltage on them to eliminate deflection).

With the above approach, it is possible to get 2°=3°−1°; 3°=zero on all but 3°; 4°=3°+1°, 5°=9°−3°−1°; etc. . . . .

In accordance with a further aspect of the concepts described herein, a stack of polarization gratings each having a grating pitch, the stack having a first end and a second end and, the polarization grating stack including N stages wherein one or more of the N stages in the stack comprise a first set of gratings which direct an incident beam through angles lying substantially in a first plane and one or more of the N stages in the stack comprise a second set of gratings which direct an incident beam through angles lying substantially in a second, different, plane lying at an angle relative to the first plane and wherein each of the N stages provide one of a plurality of deflection angles and wherein the N stages are arranged such that a stage having the smallest deflection angle is nearest the first end of the stack and a stage having the largest deflection angle is nearest the second end of the stack and wherein the deflection angles of the gratings in each set are chosen such that the grating pitch of each grating is at least one of: substantially twice the grating pitch of another member of the set; or substantially one-half the grating pitch of another member of the set.

In one embodiment, one or more of the N stages of the first set of gratings are interleaved with one or more of the stages of the second set of gratings.

In one embodiment, each of the N stages is provided as a binary stage with each binary stage providing two deflection angles.

In one embodiment, each of said N stages in said polarization grating stack comprises a switchable half-wave plate followed by a single passive polarization grating, wherein each of said passive polarization gratings is fixed in operation and not itself electrically controllable.

In one embodiment, each of said N stages in said polarization grating stack comprises a switchable half-wave plate followed by an active polarization grating having selectable deflection angles.

In one embodiment, one or more of the N stages of the first set of gratings are interleaved with one or more of the stages of the second set of gratings; and each of the N stages is provided as a binary stage with each binary stage providing two deflection angles

In one embodiment, the number of stages in the first set is equal to the number of stages in the second set and each of the stages of the first set of gratings is interleaved with the stages of the second set of gratings.

In accordance with a further aspect of the concepts described herein, a stack of polarization gratings each having a grating pitch, the stack of polarization gratings having a first end and a second end, the polarization grating stack comprising a plurality of binary stages, each of said binary stages comprising: (a) at least one liquid crystal wave plate (LCWP); and (b) at least one polarization grating; and wherein each of said plurality of binary stages provides two selectable deflection angles and wherein the plurality of binary stages are arranged in order of increasing deflection angle magnitude between the first end and the second end such that the stage with the largest deflection angle magnitude is nearest the second end of the polarization grating stack.

In one embodiment, the polarization grating stack provides two-dimensional angular control of an optical signal provided thereto.

In one embodiment, at least some of said plurality of binary stages in said polarization grating stack comprise a first set of stages which direct an incident beam through angles lying substantially in a first plane; at least some of said plurality of binary stages in said polarization grating stack comprise a second set of stages which direct an incident beam through angles lying substantially in a second, different, plane lying at an angle relative to the first plane; and at least some of the stages of the first set of stages are interleaved with at least some of the stages of the second set of stages.

In one embodiment, at least some of said plurality of binary stages in said polarization grating stack direct an incident beam through angles lying substantially in a first plane; and at least some of said plurality of binary stages in said polarization grating stack direct an incident beam through angles lying substantially in a second, different, plane lying at an angle relative to the first plane.

In one embodiment, at least some of said plurality of binary stages in said polarization grating stack which direct an incident beam through angles lying substantially in the first plane are interleaved with at least some of said plurality of binary stages in said polarization grating stack which direct an incident beam through angles lying substantially in the second plane.

In one embodiment, at least two pairs of the stages of the first set of stages are interleaved with at least two pairs of the stages of the second set of stages proximate the second end of the polarization grating stack.

In one embodiment, each of the binary stages in said polarization grating stack corresponding to the first set of stages is adjacent to at least one of the binary stages in said polarization grating stack corresponding to the second set of stages.

In one embodiment, the deflection angles of the gratings in each set are chosen such that the grating pitch of each grating is twice the grating pitch of a following member of the set lying closer to the second end of the stack.

In one embodiment, the deflection angles of the gratings in each set are chosen such that the grating pitch of each grating is twice the grating pitch of an immediately following member of the set lying closer to the second end of the stack.

In one embodiment, the grating pitch of the gratings in the set are chosen such that the grating pitch of each grating is twice the grating pitch of a succeeding grating lying closer to the second end of the stack.

In one embodiment, the grating pitch of the gratings in the set are chosen such that the grating pitch of each grating is twice the grating pitch of the immediately succeeding grating lying closer to the second end of the stack.

In one embodiment, each stage in each set of said polarization grating stack comprises a switchable half-wave plate followed by a single passive polarization grating and wherein the deflection angles of the gratings in each set are chosen such that the grating pitch of each grating is substantially twice the grating pitch of the following member of the set lying closer to the second end of the stack.

In accordance with a further aspect of the concepts described herein, a stack of polarization grating stack having a first end and a second end, the polarization grating stack comprising N binary stages, with each of the N stages providing one of two deflection angles and wherein the N stages are arranged in order of increasing deflection angles such that the stage with the largest deflection angle is nearest the second end.

In one embodiment, at least some of said plurality of binary stages in said polarization grating stack comprise a first set which deflect an incident beam through angles lying substantially in a first plane and at least some of said plurality of binary stages in said polarization grating stack comprise a second set which deflect an incident beam through angles lying substantially in a second, different, plane lying at an angle relative to the first plane; and at least some of the stages of the first set are interleaved with at least some of the stages of the second set.

In one embodiment, each of the N stages comprises at least one liquid crystal wave plate (LCWP) and at least one polarization grating.

In one embodiment, at least some of the N stages are disposed to deflect an incident beam by angles lying substantially in a first plane and at least some the N stages are disposed to deflect an incident beam by angles lying substantially in a second, different, plane.

In one embodiment, the stages disposed to deflect the incident beam by angles lying substantially in the first plane are interleaved with the stages disposed to deflect the incident beam by angles lying substantially in the second plane.

In one embodiment, the first stages in the first set is interleaved with the stages in the second set.

In one embodiment, the polarization grating stack comprises at least two binary stages.

In one embodiment, each stage in said polarization grating stack comprises a switchable half-wave plate followed by a single passive polarization grating.

In accordance with a further aspect of the concepts described herein, a stack of polarization gratings, each having a grating pitch, the stack having a first end and a second end, and the polarization grating stack comprising a plurality of ternary stages, each of said ternary stages comprising at least one liquid crystal wave plate and at least one active polarization grating wherein each stage provides a selectable deflection angle and wherein the stages are arranged in order of increasing deflection angle magnitude between the first end and the second end such that the stage with the largest deflection angle magnitude is nearest the second end of the polarization grating stack wherein one or more of said plurality of stages deflect an incident beam through angles lying substantially in a first plane and one or more of said stages deflect an incident beam through angles lying substantially in a second, different, plane lying at an angle relative to the first plane; and at least some of the stages disposed to deflect the incident beam by angles lying substantially in the first plane are interleaved with at least some of the stages disposed to deflect the incident beam by angles lying substantially in the second plane.

In one embodiment, each of the stages disposed to deflect the incident beam by angles lying substantially in the first plane are interleaved with the stages disposed to deflect the incident beam by angles lying substantially in the second plane.

### BRIEF DESCRIPTION OF THE DRAWINGS

The foregoing features of the circuits and techniques described herein, may be more fully understood from the following description of the drawings in which:

FIG. 1 is a cross-sectional view of an optical aperture;

FIG. 1A is a cross-sectional view of a portion of an optical aperture;

FIG. 2 is a top view of a composite aperture; and

FIG. 3 is a plot of a control scheme for DFLC devices.

### DETAILED DESCRIPTION OF THE PREFERRED EMBODIMENTS

Described herein is the use of a fast-scanning optical phase array (FS OPA) within an electronic beam-steering-based aperture suitable for use in a system such as the Adaptive Photonically Phase-Locked Elements (APPLE) system, for example.

Also described is a stack of polarization gratings (PGs), each controlled by a liquid-crystal wave plate which may be used in the APPLE system.

Before describing a fast-scanning optical phase array and a polarization grating architecture, some terminology is defined. As used herein, the term “aperture module” or more simply “aperture” to an optical train having one or more OPA devices, a polarization grating (PG) stack having at least some interleaved PG elements, an adaptive optics (AO) portion, coarse OPAs and one or more half wave plates. One exemplary aperture is a modified APPLE architecture referred to as an “APPLEt.” The terms “composite aperture,” “optical phased-array” or more simply “array” refer to a plurality of apertures arranged to cooperate together. In the context of optical phased-array beam steering, a “spot” is defined as an angular shift of λ/D where λ is the operating wavelength and D is the beam diameter. As is well known in the art, a one-spot angle shift at a point in the optical train where the beam is collimated and of diameter D1 (i.e., a shift of λ/D1) will be transformed into a different angle λ/D2 by any afocal lens system which converts the beam diameter from D1 to D2. This is still one “spot” at the new beam diameter: an angle measured in spots is invariant under magnification.

Referring now to FIG. 1, an optical aperture 10 includes a PG stack 12, a lens 14, a coarse steering portion 16, an adaptive optics (AO) portion 18 and a lens 20 and a waveplate 22 (e.g. a switchable waveplate). Light propagating through the aperture is represented with reference numeral 23. Waveplate 22 is disposed between an end of the PG stack and the output of the aperture. Waveplate 22 is controlled to set a polarization of the aperture 10 to a desired state. It should be appreciates that use of a polarization-switching subsystem at the output end of the aperture results in an output polarization state which depends upon the settings of the various switchable devices in the PG stack. In a composite aperture (or multiple-aperture array, as shown in FIG. 2, for example), coherent combining of the outputs in the far field requires that all the emitters emit substantially the same polarization. Thus, switchable waveplate 22 is used to set the polarization to a desired state.

In one embodiment, PG stack 12 comprises a plurality of binary stages 12a-12N with each stage comprising at least one OPA device and a passive PG. In an alternate embodiment, PG stack 12 includes one or more active liquid crystal half wave plates (LCWHPs). In one embodiment PG stack 12 comprises a plurality of binary stages, with each of the binary stages comprising at least one liquid crystal wave plate (LCWP) and at least one polarization grating wherein each stage provides a selectable deflection angle. Significantly, the stages are arranged in order of increasing deflection angle magnitude such that the stage with the largest deflection angle magnitude is nearest the aperture output. In general, the deflection angle magnitudes and number of stages N in the PG stack are selected to provide a desired field of regard (FoR).

PG stack 12 provides two-dimensional angular control of an optical signal provided thereto. To provide such two-dimensional angular control, at least some of the plurality of binary stages in PG stack 12 corresponding to a first set of PG stages direct an incident beam through angles lying substantially in a first plane and at least some of the plurality of binary stages in the PG stack 12 correspond to a second set of PG stages which direct an incident beam through angles lying in a second different plane lying at an angle relative to the first plane. The first and second planes may or may not be orthogonal to each other. Thus, a wide range of two-dimensional angular control is available. Significantly, at least some of the stages of the first set are interleaved with at least some of the stages of the second set. In one embodiment each of the binary stages in PG stack 12 corresponding to the first set of stages is adjacent to at least one of the binary stages in PG stack 12 corresponding to the second set of stages.

With the architecture illustrated in FIG. 1, aperture 10 may be provided having a fixed feed-point which allows the system to be fed by fixed fiber lasers and/or by free-space lasers.

Referring now to FIG. 1A, a portion of an optical aperture 10′ which may be the same as or similar to aperture 10 of FIG. 1 includes a liquid-crystal half-wave plate (LCHWP) 30 disposed proximate (here adjacent), one end of a PG stack 32. In this exemplary embodiment, PG stack 30 comprises a first plurality or set of here seven, binary stages 32a-32g for a first steering direction and a second plurality or set of, here seven, binary stages, 34a-34g for a second different steering direction. Thus PG stack 32 enables steering in two dimensions. The steering directions may correspond to two orthogonal directions (e.g. azimuth and elevation) or non-orthogonal directions.

Each of the binary stages comprises at least one liquid crystal wave plate (LCWP) (OPA devices) generally denoted 36 in FIG. 1A and at least one polarization grating 38a-38g, 40a-40g. Each stage 32a-32g, 34a, 34g thus provides a selectable deflection angle and the stages are arranged in order of increasing deflection angle magnitude such that the stage with the largest deflection angle magnitude is nearest the aperture output. In this exemplary embodiment, the angle of deflections provided by the stage of PG stack 32 are on the order of ±0.25°, ±0.5°, ±1.0, ±2.0°, ±4.0°, ±8.0°, ±16.0°. Other deflection angle magnitudes may, of course, also be used. In general, the deflection angle magnitudes and number of stages in the PG stack are selected to provide a desired field of regard (FoR).

In the embodiment of FIG. 1A, the first set of stages 38a-38g are interleaved with the second set of stages 40a-40g. The number of stages in the first set need not be equal to the number of stages in the second set. Also, the deflection angle magnitude provided by the first set need not be equal to the deflection angle magnitude in the second set. In one embodiment, each of the binary stages in the PG stack corresponding to the first set of stages is adjacent to at least one of the binary stages in PG stack 12 corresponding to the second set of stages.

A coarse steering portion is provided from a plurality, here two, OPA devices 46a, 46b and AO portion is provided from a plurality, here three, OPA devices (TTOPAs) 48a, 48b 48c.

The modified APPLE architecture described above provides a continuous slew rate in the range of 3-5 deg/sec or greater which is desired for some applications. The architecture uses a so-called “saccade” scanning mode, but is implemented with a Fast Steering OPA (FSOPA).

This approach is enabled by design of a dual-frequency-liquid-crystal (DFLC) based FSOPA that has sufficiently few electrodes selected such that the electrodes can be hard wired for high-voltage addressing (e.g. up to the range of about 200V) and therefore can switch much faster than relatively low voltage OPAs. Thus, the approach described herein eliminates the need for a mechanical fiber actuator while at the same time allowing slewing at rates which are significantly higher (i.e. faster) than slew rates achievable with existing OPAs.

In one embodiment, initial performance estimates suggest that an APPLE system having the FSOPA slews at about 8 deg/sec while having slewing loss levels similar to those of current APPLE systems having slew rates of about 1 deg/sec. This represents nearly an order of magnitude improvement.

Major advantages of the approach include, but are not limited to the following: (1) this approach utilizes existing LC materials; (2) this approach utilizes existing application specific integrated circuits (ASICs) to provide desired control signals to the OPAs; (3) this approach utilizes existing DFLC addressing techniques used for polarization grating work; (4) this approach does not require a piezo fiber actuator, (5) this approach allows fiber to be rigidly mounted, which should help mitigate fibermotion-induced higher order modes and simplify packaging; (6) this approach enables future use of free-space laser sources for higher power or fewer higher order modes; (7) the FSOPA may be able to replace Fast Steering Mirrors (FSMs) in some applications; and (8) FSOPAs are approximately 10× faster than mechanical FSMs now available while having approximately the same angular range and having other performance parameters which are superior to FSMs.

An AO typically has far fewer electrodes than does an OPA, need not use voltage-limited addressing application specific integrated circuits (ASICs), and can therefore be driven with higher voltage. The current APPLE AO has only 127 pixels (electrodes) compared to thousands for the OPAs. One AO design (such as that developed under APPLE Phase 0) provides an example of direct connection of each of the 127 AO pixels to a separate leadout conductor. In one embodiment driving such an AO design with perhaps as high as 200V signals appears to be practical, and represents a short-term path to a very fast AO provided as a DFLC AO, using currently available DFLC material. Note that a pixel count of 127 is much larger than typically needed to compensate for external aberrations such as propagation through the atmosphere, but we include such an AO to support fine control of wavefront error (WFE) to eliminate aberrations which arise internal to our system. Such aberrations may be present either because of deliberately relaxed fabrication tolerances (to reduce fabrication cost) or because of thermally-induced WFE driven by absorption of energy in a system used with a high-power laser source.

The practicality of such a DFLC AO implies that an OPA with a similarly low electrode count would also be practical. Such an OPA would have a very limited steering range. Saccade operation, however, provides the means to use an OPA with a small angular range but high speed to provide APPLE with high speed slewing.

It has been recognized that a combination of OPAs and mechanical steering can increase slew rates over that available with OPAs alone while maintaining the precision and agility of the OPAs and most of the speed of the mechanical steering. Below is provided a description of how such a hybrid slewing system works based upon a so-called saccade operation.

APPLE uses a fiber feed in the focal plane of a beam expanding collimator. A piezoelectric (PZT) actuator provides a small amount of transverse motion of the fiber tip (of order ±100 μm), which is transformed to small angular motions of the collimated output beam (of order ±50 μrad, depending on the effective focal length of the collimator). This function provides rapid tip/tilt correction for adaptive optics in the current APPLE system. It was recognized that that same PZT actuator can also be used to provide slewing of the output beam, albeit only over small angles. However, when the PZT actuator comes to the end of its range, it can be reset to the opposite end of its dynamic range, a second ‘conventional’ OPA simultaneously re-steered to compensate for the PZT reset, and the slewing continued, resulting in an angularly continuous (but temporally modulated) slew over the entire APPLE field of regard. With this operating scheme, the OPAs need only be updated once every time the PZT actuator is scanned over its full dynamic range, rather than once or more for every incremental beam motion, and this results in a higher net slew rate than the OPAs can provide on their own. This operating mode is referred to as “saccadic” operation, in analogy to the rapid eye movements that facilitate human vision.

The PZT fiber actuator of the current APPLE system provides only about ±2 spots motion and does so only at a 1.5 kHz bandwidth. Prospects for increasing either the angular motion or the speed are considered unlikely for high-power array designs, whereas increases in both are needed to profit from saccade operation and obtain the desired slew rates. However, as described herein a small-angle fast-steering OPA can be used to accomplish this task.

It is desirable for the FSOPA to have as large a steering range as possible at a given average throughput because that reduces frequency of regular (slow) OPA resets and therefore results in higher net slew rates. However, the larger the FoR, the more OPA electrodes are needed to maintain an acceptably high steering efficiency, and currently available interconnect technology will not support more than 100 to 200 traces connecting high voltages to a 10- to 20-mm sized OPA. It is thus believed that an electrode count on the order of at least 100 should be acceptable.

Based upon packaging experience with APPLE systems (e.g. the APPLE Phase 0 AO, having 127 pixel/leadouts), 100 electrodes driven at 200V is considered doable. It should be noted (see reference McManamon et al., “Optical Phased Array Technology” (1996)) that steering with N phase steps per ramp implies a steering efficiency of sin c²(Π/N), i.e., for N>4 an efficiency of roughly 1-2/N². For a Phase 2 APPLEt, the OPAs and AOs are to be located within the collimator, where the beam is about one-half the output beam diameter; ie, the device should have a clear aperture of about 13 mm. Therefore in one embodiment, consider an angular motion of ±10 spots with a steering efficiency of about 97% (implying approximately 10 phase steps per phase ramp), which requires 100 electrodes. This means the electrodes have a 130 micron pitch. The device would have a 20 spot FoR. This compares to about 5 spots for a system using a PZT actuator.

Referring now to FIG. 2, a composite aperture 50 comprises a plurality of apertures generally denoted 52. Apertures 52 may be of the type which are the same as or similar apertures 10, 30 described above in conjunction with FIGS. 1 and 1A. As mentioned above, use of a polarization-switching subsystem at the output end of an aperture results in an output polarization state dependent upon the settings of the various switchable devices in the above described PG stacks. Thus, in composite aperture 50, coherent combining of the outputs in the far field requires that all the emitters emit substantially the same polarization. Thus, a switchable waveplate, such as waveplates 22, 30 described above in conjunction with FIGS. 1 and 1A, are used to set the polarization to a desired state and thus enable coherent combining of the outputs.

Referring now to FIG. 3, a control scheme for DFLC devices has been demonstrated which supports continual phase changes at about a 4 kHz update rate, and extension to near 10 kHz appears feasible. In this mode, the each phase-shifter within the OPA device moves linearly from one phase state, at the start of an update period, to the second one, at the end of the period. One existing scan-loss model is approximately applicable to this case, with an effective time constant of the update period (e.g., 250 μs at 4 kHz) divided by 1.8. This scan-loss model states that the scan loss is 1 dB at a scan rate of 0.25 times the wavelength divided by the aperture diameter per response time constant, here 140 μs. Thus the slew rate in object space for a 1 dB loss would be 0.076 radian (4.4°) per second, assuming an output aperture diameter of 25 mm (i.e., a magnification of about 2) and a wavelength of 1.064 μm.

This loss scales linearly with slew rate. At 4.4°/s, the 20 spot (840 μrad) saccade period comes out to be 11 ms. The blocking time, when the conventional OPA resets, is about 2 ms, so the additional loss averaged over this interval is also about 1 dB. The point design appears to adequately address the problem.

It should be noted that the “conventional” OPA need not have full angular addressability, i.e., it can be a “coarse” OPA as is well known in the art (ref to McManamon again). Such a device can have many electrodes which are interconnected in a periodic manner, i.e. the device is made up of a number of identical subarrays.

The device described herein, on the other hand, can steer with good efficiency to a larger angle while requiring few pinouts. Its available steering angles are quantized by the periodicity requirements implicit in a subarrayed structure; the phase pattern must be periodic in the subarray width. This is not a significant limitation if its period is chosen to be consistent with the ±10 spot FSOPA steering range.

Saccade operation impacts system performance in a number of ways. Below are considered two issues.

In one embodiment having an FSOPA with a 20 spot FoR, when the FSOPA reaches the edge of its 20-spot FoR, it resets, and the ‘standard’ larger-angle OPA is updated to compensate for the angular change of 20 spots. Kalman estimators can be used to predict where the target should have moved to during the reset so that when the update is made the beam can be put back on the target. The shorter the reset time, the better the assumption that the target hasn't changed course beyond the expected Kalman uncertainty. For a 2 ms reset time this seems to be a reasonable expectation for motions along the target down-range trajectory. Whether the target is likely to move (or through platform jitter appear to move) more than one spot cross-range in 2 ms needs to be considered.

The resets of the saccade operation effectively reduce power on the target. For an array of APPLEts, the reset losses can be mitigated by programming the resets to occur at different times for the different APPLEts. For the above example with an array of six apertures, this would reduce the reset power reduction to about 15%.

Both of these saccade drawbacks can be mitigated with faster reset OPAs. For the system here described, the coarse OPAs which support the resets will have a pinout substantially less than 100, so these devices are also candidates for use of DFLC. In that case the dead time during a saccade is simply one update interval

Development of a FSOPA steering system also enables elimination of a PZT fiber actuator used in present apertures.

The FSOPA described herein is faster (by almost an order of magnitude) and has a 4-fold larger angular range than does the PZT fiber actuator utilized in existing optical apertures. Furthermore, the FSOPA described herein can do the same job as the PZT actuator, namely, tip/tilt correction for the adaptive optics, but do it faster, and it can simultaneously support the fast slewing required. Thus, an APPLE system will perform better with two FSOPAs (note that one FSOPA is needed for each dimension) replacing a PZT fiber actuator, and there are other practical reasons for eliminating the PZT actuator.

Furthermore, replacement of the PZT fiber actuator with an FSOPA eliminates the last mechanical motion in the APPLE system, resulting in a true non-mechanical, all-electronic system, and a much more robust system.

The FSOPA is at least as robust as a conventional OPA, which from tests is operational to hundreds of g's of shock acceleration.

One potential problem with a current APPLE system is the demonstrated presence of higher order modes in the over-moded delivery fiber. These modes move around within the fiber core when the fiber is bent, change relative phases, and cause the output beam to both deform and move about, and that motion appears to preclude meeting the pointing accuracies desired for some applications.

Replacement of the PZT fiber actuator with an FSOPA means that the fiber no longer needs to move and can be firmly anchored, which will presumably significantly reduce mode motions.

A fixed feed-point also allows the APPLE system to be fed by free-space lasers; APPLE will no longer be restricted to fiber lasers. While fiber lasers offer high efficiencies, other laser types do offer other potential advantages, and the new APPLE design will allow tradeoffs to be made. As an example, the so-called Semi-Guiding High Aspect Ratio Core (SHARC) laser developed by Raytheon SAS, offers an alternate path to mitigation of stimulated Brillioun scatter because the effective core size is much larger than even the over-moded 25 micron core fibers currently used in APPLE. If the current SBS mitigation approach taken by RIFL (phase modulation at several GHz) proves to be incompatible with the APPLE control systems, SHARC offers a ready solution. It is compact and relatively high efficiency (25% wall plug efficiency predicted). It also offers prospects of operating at higher output powers (10 kW) than is predicted for single-mode fiber lasers (3-5 kW), meaning that the per aperture power of an APPLE system would be limited by the damage levels of the APPLEt components rather than the fiber lasers. One probably wants to use as high power as possible per subaperture in order to minimize the number of APPLEts needed to scale an array to the desired power level. The SHARC laser offers that prospect, and the new APPLE architecture makes the use of a SHARC laser feasible.

The use of free-space lasers to drive APPLE also means that more mature solid-state or even HELLADS type lasers could be used to accelerate the availability of a high power APPLE system. There may be situations where development time or the number of subapertures is a more important tradeoff than laser efficiency, and in those cases the new architecture described herein would seem to be a promising candidate.

Next described is a stack of polarization gratings, each controlled by a liquid-crystal wave plate (LCHWP).

In one application, this stack of gratings comprises a component suitable for use in the Adaptive Photonically Phase-Locked Elements (APPLE) program.

A review of systems to perform non-mechanical steering of optical beams is presented in “Review of Phased Array Steering for Narrow-Band Electrooptical Systems,” authored by McManamon et al. and published in the proceedings of the IEEE|Vol. 97, No. 6, June 2009. This paper discusses work by Escuti and others on high-performance short-pitch polarization gratings (PGs) for beam steering.

Disclosed herein is a half waveplate-PG architecture which is improved compared with conventional half waveplate-PG architectures. In general, all such architectures serve as zone selectors. Herein a “zone” is a region of output-angle space to the center of which the PG stack directs the input beam if the zone-fill OPA subsystem is set for zero deflection angle. The full zone is then made accessible by steering the zone-fill OPA subsystem appropriately.

The devices described in the above-noted McManamon reference (such as those described by Escuti and others) are nominally half-wave plates wherein the optic axis lies in the plane of the device but is oriented in a continually-varying in-plane direction. The pitch P of this rotation, i.e., the distance in-plane over which a full revolution takes place, governs the diffraction angle when they are illuminated with circularly polarized light. The diffraction arises because, while the output polarization is everywhere the same (and is oppositely handed to the input light), there is a phase shift which varies continuously along the in-plane direction of variation of orientation. It should be noted that different theoretical treatments define the pitch differently; for example, since the optic axis is defined only up to a 180° rotation, another possible definition of pitch is one-half the definition we use here. The treatment here is self-consistent with our definition of P as for a full rotation.

Light incident at angle θ₁ in the plane containing the surface normal and the direction along which the orientation varies is converted to the opposite circular polarization and steered to a new direction θ₂ such that:

sin θ₂=sin θ₁+M(2λ/P) Equation (1)

where:
M is the value of the S3 component of the normalized Stokes vector of the input light and has a value of either +1 or −1 for RCP or LCP light, respectively.

In the small-angle approximation, this equation says that if the input is chosen as LCP or RCP, the output light will be steered by ±2λ/P, respectively, from its initial direction. A stack of such PG devices alternating with switchable (e.g., liquid-crystal) half-wave plates (SHWPs) is described by McManamon and constitutes a potentially low-loss large-angle discrete beamsteerer, i.e., a zone selector, which would function in two dimensions if two such stacks combined. Further discussed is a binary tree of such devices, each device being followed by one of half (roughly) the pitch and thus twice the steering angle. Also discussed is such a stack where each PG device is “active”, i.e. is actually a liquid crystal layer having the stated varying orientation and wherein application of a large voltage will stand the molecules on end, eliminate the effective birefringence, and thus give a zero deflection state in addition to the positive and negative ones supported by the “passive” PG. It should be noted that use of such a polarization-switching subsystem at the output end of the aperture will result in an output polarization state which depends on the settings of the various switchable devices in the PG stack. In a multiple-aperture array, coherent combining of the outputs in the far field requires that all the emitters emit substantially the same polarization. Thus a standard part of such an architecture is a final switchable waveplate which is used to set the polarization to the desired state.

The prior art references do not suggest a true binary tree of deflection angle stages. In one prior art reference, each stage provides a deflection of 0. +S, and −S, and S varies in a binary manner from one stage to the next. For example, to cover a ±30° range with 2° resolution, 4 stages with S=respectively 2°, 4°, 8°, and 16° are required. An angle of +30° is provided as 2°+4°+8°+16°. An angle of −2° is achieved in the same manner using −16° instead of +16°, or, more simply, as −2° for the first stage and zero for all the other stages. Two stage types are described. If active PGs are used, a stage consists of a SHWP followed by a single PG. If passive PGs are used, a stage consists of two PGs of deflection S/2, each preceded by an SHWP.

Note that each stage includes two active devices, either two SHWPs or a SHWP and an active PG, yet achieves only three output states rather than the four which would be available in a true binary case with two input controls. Depending upon the state of the SHWPs, the two deflections may be (++) resulting in +S, (−−) resulting in −S, or (+−) or (−+), resulting in zero. The passive architecture thus requires eight PGs, the active one four. In both cases there is more than one set of control settings (SHWP or active-PG) for many of the total-deflection angles. Accordingly, in view of the above, it can be seen that the architectures disclosed in prior art systems are wasteful of active components, which are a significant source of optical loss and control complexity.

In contrast, consider five stages, each including a SHWP followed by a single passive PG, with deflections S of 1°, 2°, 4°, 8°, and 16°. This would support a FoR of ±31° with 2° resolution (the zero-deflection state is unavailable). For example, 1° is provided by selecting −S on all the PGs except the 16° one. The next available angle, +3°, is provided as: (+1°−2°−4°−8°±16°). Thus, for the passive-PG case, the novel approach just described requires roughly one-half as many PGs for the same resolution as proposed in the prior art approaches described in the aforementioned references.

Turning now to the active-PG case, if deflections of 1°, 3°, 9°, and 27° are used, it is possible to cover ±40° with the same number of PGs as used in prior art systems while achieving an improved resolution of 1°. To achieve +40°, all PGs are set to +S. One degree (1°) is achieved by zeroing all PGs except the first (i.e., applying voltage on them to eliminate deflection).

One achieves 2°=3°−1°; 3°=zero on all but 3°; 4°=3°+1°; 5°=9°−3°−1°; etc. Prior art discloses such a “ternary” stack (each grating deflects three times as much as its predecessor) for beam deflection in a single plane, or two such systems in series for deflection in two planes, i.e., full two-dimensional steering. However, it is neither taught nor, so far as is known, possible to arrange such a ternary tree with all of the large-angle PGs near the output end; the required polarization states always conflict, for some of the desired zones. Such an increasing-angle (therefore, interleaved, for two-dimensional steering) arrangement is desirable to control the loss of beam power caused by “walkoff”, the departure of the beam centerline from the centerline of the optical system. If this interleaving is not done, either the system aperture must be made much larger or large losses must be accepted, at least for steering over usefully large angles (say, a FoR of ±30°). Neither alternative is attractive. However, no means is known of interleaving the gratings in each of the two steering directions, for the ternary active-PG case, without adding additional components, e.g., more SHWPs. A true binary tree such as that taught and described herein does not suffer from this limitation.

As mentioned above, as the angles vary by multiples of two or three the grating pitch varies approximately inversely, by multiples of one-half or one-third. A preferred embodiment is to have the grating pitch vary exactly by multiples of one-half or one-third, respectively, rather than having the angles vary exactly by factors of two or three. This will ensure that the zone centers are evenly spaced, which is useful in ensuring that the steering efficiency of the zone-fill OPA subsystem is not degraded in oversized zones. Note that the grating deflection angle is defined as the angle through which it deflects a beam impinging on it at normal incidence; the actual deflection angle varies with angle of incidence in accordance with Equation 1 above. That equation shows that it is the sine of the deflection angles which are additive, not the angles themselves. As an example, consider the two successive transitions between nominally −3° (commanded deflections {−16°, +8°, +4°, +2°, −1}) and −1° ({−16°, +8°, +4°, +2°, +1°}) and then between −1° and +1° ({+16°, −8°, −4°, −2°, −1°}). Using Equation 1, and assuming that the grating deflection angles are precisely the nominal values, we find that the three actual output angles are −2.8236°, −0.8226°, and +0.82260, exhibiting a much larger step in the first transition (2.0010°) than in the second (1.6451°). In contrast, if the 1° grating is designed to be exactly 1° and the others are designed as arcsin(N×sin(1°)), i.e., the pitches vary exactly by factors of one-half, then the nominally 16° grating is actually arcsin(16×sin(1°))=16.21480. The three angles calculated via Equation 1 are found to be −3.0012°, −1.0000°, and +1.0000°, exhibiting the desired uniform zone spacing.

As the external angle of incidence α of light on the PG increases, the retardation of each section of the device departs from the ideal behavior, which is a half-wave plate at a defined angle. In particular, the retardation R differs from the nominal (normal-incidence) retardation R₀ depending upon the angle η between the plane of incidence and the plane containing the optic axis.

The dependence is approximately given by:

R≈R₀(1+(αᵢ²/2)cos 2β Equation (1)

where αⱼ is the internal angle of incidence arcsin([sin α]/n)≈α/n, n being the index of refraction. It should be noted that the question of whether the ordinary or extraordinary index is meant is mooted by the nature of the present approximation; the full calculation really requires a “four-wave” vectorial calculation which may be accomplished using analysis packages such as RSoft. The loss arising from this variation is estimated by noting there are two effects. First, since the retardation is incorrect, the output light is in general elliptical and thus couples imperfectly to the average polarization (and it is assumed it is the same as would occur at normal incidence, namely, circular). Second, the phase shift will also be in error.

The first effect is treated using a small-error approximation. The fractional power coupling 1−L_{P} (here defined in terms of the loss L_{P}) between two polarization states separated by angular distance D on the Poincaré sphere is well known to be cos²(D/2)≈1−D²/4. The retardance R₀ is one half-wave, i.e., π radians, and carries the initial circular polarization nominally half-way around the sphere to the emerging, opposite, circular polarization. Thus it can be seen that D=R−R₀ and finally:

L_{P}=D²/4=¼(π(αᵢ²/2)cos 2β)²=(π²α⁴/16n⁴)cos² 2β Equation (2)

Averaging over the whole PG, i.e., over a uniform distribution of β, an estimate of the loss may be expressed as:

L_{P}=π²α⁴/32n⁴ Equation (3)

which is 1% for α of 40° (assuming n=1.5)—a very small effect.

The second loss mechanism, arising from phase errors, can be approximated by noting that the relevant phase is the Berry phase, which is related to the solid angle on the Poincaré sphere subtended by the arc over which the polarization is carried. Thus, the phase error φ is up to (π/2) times the retardation error R−R₀. Applying the usual Strehl argument, i.e., taking the phase dependent loss to be L_{S}=φ², results in Equation (4) below:

L_{φ}=φ²=((π²α²/2)cos 2β)²)=π⁴α⁴/32n⁴ Equation (4)

This is a factor of π² larger than the polarization loss L_{P}. This may be an overestimate because of some considerations about the locus of the transmitted state. In any case, the losses are quite small even for angles of incidence well above the needs of a program such as the Adaptive Photonically Phase-Locked Elements (APPLE) program. Thus, the concepts, structures and techniques described herein are believed to be a suitable replacement for angle-tuned holographic optical elements (HOEs) in wide-angle beam steering applications.

The effect of smearing of grating by ray slant in finite-thickness device will next be discussed. The PG will have some finite thickness T. Rays at an angle of incidence α traverse the device at an internal angle with respect to the normal of αᵢ. Choosing coordinates with X through the thickness and with Y the transverse direction of beam steering. The local orientation of the HWP making up an element of the PG is assumed to be constant through the thickness, i.e., is independent of X. Since this orientation β varies along Y as β=2πy/P, it can be seen that the ray sees a range of values of orientation Δβ=2πT/P tan αᵢ as it passes through the device. The question is what effect this has on the phase and polarization of the output light.

The first-order effect can be modeled by breaking the thickness into two layers. The orientation of each layer is taken to be the average orientation in that layer. Thus, the HWP is modeled as a quarter-wave plate (QWP) of orientation −Δβ/4 away from where it is supposed to be, followed by one having an orientation error corresponding to +Δβ/4. A first-order visualization on the Poncaré sphere of this stack says that the resulting output polarization state is shifted away from the desired state as if via a retardation error of Δβ. Just as above in the case of Eq. 2 and as before using the small-angle approximation and replacing tan αᵢ by α/n, one expects a loss D²/4=Δβ²/4, i.e. an “obliquity loss” L_{O} given by Equation (5):

L_{O}=Δβ²/4=¼((2πTα)/(nP))²=((παTΔθ)/(2λn))²=((παΔθ)/(4nΔn))² Equation (5)

In the third form, P is replaced by its equivalent from Eq. 1 in terms of Δθ≈ sin θ₂−sin θ₁. In the fourth, T is replaced by λ/(2Δn), appropriate for an optimally-thin device of birefringence Δn. If one were to design a PG-based system with a ±40° field of regard, the last PG would have α=Δθ=20° (i.e., 0.35 radian) and an L_{O} of about 3%, assuming a birefringence of about 0.35 (T/λ=1.5 for a HWP layer).

Architecture choice for minimum system loss is next discussed. Consider a system with a stack of PGs for zone-select preceded by a pair of OPAs for zone-fill.

If operating the OPAs at small steering angles, under which assumption the steering loss is approximately linear in steered angle θ_{S}, the OPA loss can be assumed to be L_{S}=Gθ_{S}. Likewise, it can be assumed that each of the N stages of PG has loss L_{G}. The smallest PG steering angle is θ₀. The system field of regard F is taken as a given value and N is selected N to reduce or ideally minimize total loss. The calculation below is for a 1D steering; double the loss in dB for full 2D coverage.

### Binary-Staged Architecture (Passive PGs)

The zone size is 2θ₀ and the maximum OPA steering angle is θ₀. For N stages, the number of zones is 2^{N}−1 and F is the zone size times this number plus one-half a zone-width at each end, i.e., 3^{N}θ₀. N may be chosen to reduce, or ideally to minimize, the total loss NL_{G}+Gθ₀=NL_{G}+GF/2^{N+1}.

### Ternary-Staged Architecture (Active PGs)

The zone size is θ₀ and the maximum OPA steering angle is θ₀/2. For N stages, the number of zones is 3^{N}−1 and F is the zone size times this number plus half a zone-width at each end, i.e., 3^{N}θ₀. N may be chosen to reduce, or ideally to minimize, the total loss NL_{G}+Gθ₀2=NL_{G}+GF/2×3^{N}).

The table below lists trade-offs to be made among different polarization grating architectures. The possible grating tree layouts are: binary passive, ternary active and binary active. In applications in which a minimum loss architecture is desired, a binary passive grating architecture is selected

TABLE

| Grating-Tree | | | Binary |
|---|---|---|---|
| Layout | Binary Passive | Ternary Active | Active |
| Stage Makeup | LCHWP + Passive | LCHWP + Active | Active PG |
| | PG | PG | |
| PG Angles [°] | Az, E1: 0.25, | Az, E1: 0.25, 0.75, | Unknown |
| | 0.5, . . . , 8, 16 | 2.25, 6.75, 20.25 | |
| Stages | 16 | 10 | >16 |
| Electrode Layers | 34 | 42 | >34 |
| Stack Height | 56 | 60 | >48 |
| [mm] | | | |

In the above Table, it is assumed that: (1) OPA zone-fill range: 0.25° in object space, (2) FoR nominally ±30° Az and El; (3) Binary tree: 8 stages, 2⁸=256 states (means actual FoR is ±32°); (4) Ternary tree: 5 stages, 3⁵=243 stages (means actual FoR is ±30.375°); (5) LCWP or active-PG thickness: 3 mm; (6) Passive PG thickness: 0.5 mm and Integrated onto LCWP, thickness would be <<0.5 mm and 0.5 mm allows for optional cover glass; (7) grating angles increase from input to output end to keep walkoff within acceptable range.

In view of the above, binary passive gratings are chosen for applications in which a minimum loss architecture is required.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A stack of polarization gratings each having a grating pitch, the stack having a first end and a second end, the polarization grating stack comprising:
a number, N, of stages wherein one or more of said N stages in said polarization grating stack comprise a first set of gratings which direct an incident beam through angles lying substantially in a first plane and one or more of said N stages in said polarization grating stack comprise a second set of gratings which direct an incident beam through angles lying substantially in a second plane lying at an angle relative to the first plane and wherein each of the N stages provides one of a plurality of deflection angles and wherein the N stages are arranged such that a stage having the smallest deflection angle is nearest the first end and a stage having the largest deflection angle is nearest the second end wherein the deflection angles of the gratings in each set are chosen such that the grating pitch of each grating is at least one of: substantially twice the grating pitch of another member of the set; or substantially one-half the grating pitch of another member of the set.

2. The polarization grating stack of claim 1 wherein one or more of the N stages of the first set of gratings are interleaved with one or more of the stages of the second set of gratings.

3. The polarization grating stack of claim 1 wherein each of the N stages is provided as a binary stage with each binary stage providing two deflection angles.

4. The polarization grating stack of claim 1 wherein each of said N stages in said polarization grating stack comprises a switchable half-wave plate followed by a single passive polarization grating, wherein each of said passive polarization gratings is fixed in operation and not itself electrically controllable.

5. The polarization grating a stack of claim 1 wherein each of said N stages in said polarization grating stack comprises a switchable half-wave plate followed by an active polarization grating having selectable deflection angles.

6. The polarization grating stack of claim 1 wherein:
one or more of the N stages of the first set of gratings are interleaved with one or more of the stages of the second set of gratings; and
each of the N stages is provided as a binary stage with each binary stage providing two deflection angles

7. The polarization grating stack of claim 6 wherein each grating of the second set is placed adjacent to a grating of the first set.

8. A stack of polarization gratings each having a grating pitch, the stack of polarization gratings having a first end and a second end, the polarization grating stack comprising:
a plurality of binary stages, each of said binary stages comprising:
at least one switchable half-wave plate; and
at least one polarization grating; and
wherein each of said plurality of binary stages provides two selectable deflection angles and wherein the plurality of binary stages are arranged in order of increasing deflection angle magnitude between the first end and the second end such that the stage with the largest deflection angle magnitude is nearest the second end of the polarization grating stack.

9. The polarization grating stack of claim 8 wherein said polarization grating stack provides two-dimensional angular control of an optical signal provided thereto.

10. The polarization grating stack of claim 9 wherein:
at least some of said plurality of binary stages in said polarization grating stack comprise a first set of stages which direct an incident beam through angles lying substantially in a first plane;
at least some of said plurality of binary stages in said polarization grating stack comprise a second set of stages which direct an incident beam through angles lying substantially in a second, different, plane lying at an angle relative to the first plane; and
at least some of the stages of the first set of stages are interleaved with at least some of the stages of the second set of stages.

11. The polarization grating stack of claim 8 wherein:
at least some of said plurality of binary stages in said polarization grating stack direct an incident beam through angles lying substantially in a first plane; and
at least some of said plurality of binary stages in said polarization grating stack direct an incident beam through angles lying substantially in a second, different, plane lying at an angle relative to the first plane.

12. The polarization grating stack of claim 8 wherein at least some of said plurality of binary stages is comprised in a first set, at least some are comprised in a second set, and wherein the first set deflects an incident beam through angles lying substantially in a first plane, the second set deflects an incident beam through angles lying substantially in a second plane lying at an angle to the first plane, and wherein some stages in the first set are interleaved with at least some of the stages in the second set.

13. The polarization grating stack of claim 10 wherein at least two pairs of the stages of the first set of stages are interleaved with at least two pairs of the stages of the second set of stages proximate the second end of the polarization grating stack.

14. The polarization grating stack of claim 10 wherein each of the binary stages in said polarization grating stack corresponding to the first set of stages is adjacent to at least one of the binary stages in said polarization grating stack corresponding to the second set of stages.

15. The polarization grating stack of claim 10 wherein the deflection angles of the gratings in each set are chosen such that the grating pitch of each grating is twice the grating pitch of a member of the set lying closer to the second end of the stack.

16. The polarization grating stack of claim 10 wherein the deflection angles of the gratings in each set are chosen such that the grating pitch of each grating is twice the grating pitch of an immediately following member of the set lying closer to the second end of the stack.

17. (canceled)

18. The polarization grating stack of claim 10 wherein the grating pitch of the gratings in at least one set of gratings are chosen such that the grating pitch of each grating is substantially twice the grating pitch of the nearest grating of that set lying closer to the second end of the stack.

19. The polarization grating stack of claim 10 wherein each stage in each set of said polarization grating stack comprises a switchable half-wave plate followed by a single passive polarization grating and wherein the deflection angles of the gratings in each set are chosen such that the grating pitch of each grating is substantially twice the grating pitch of the member of the set lying closer to the second end of the stack.

20. A stack of polarization grating stack having a first end and a second end, the polarization grating stack comprising N binary stages, with each of the N stages providing one of two deflection angles and wherein the N stages are arranged in order of increasing deflection angles such that the stage with the largest deflection angle is nearest the second end.

21. The polarization grating stack of claim 20 wherein:
at least some of said plurality of binary stages in said polarization grating stack comprise a first set which deflect an incident beam through angles lying substantially in a first plane and at least some of said plurality of binary stages in said polarization grating stack comprise a second set which deflect an incident beam through angles lying substantially in a second, different, plane lying at an angle relative to the first plane; and
at least some of the stages of the first set are interleaved with at least some of the stages of the second set.

22. The polarization grating stack of claim 20 wherein each of the N stages comprises at least one switchable half-wave plate and at least one polarization grating.

23. The polarization grating stack of claim 20 wherein at least some of the N stages are disposed to deflect an incident beam by angles lying substantially in a first plane and at least some the N stages are disposed to deflect an incident beam by angles lying substantially in a second, different, plane.

24. The polarization grating stack of claim 23 wherein the stages disposed to deflect the incident beam by angles lying substantially in the first plane are interleaved with the stages disposed to deflect the incident beam by angles lying substantially in the second plane.

25. The polarization grating stack of claim 23 wherein at least some of said N binary stages is comprised in a first set, at least some are comprised in a second set, and wherein the first set deflects an incident beam through angles lying substantially in a first plane, the second set deflects an incident beam through angles lying substantially in a second, different, plane lying at an angle to the first plane, and wherein stages in the first set are interleaved with at least some of the stages in the second set.

26. The polarization grating stack of claim 20 wherein said polarization grating stack comprises at least two binary stages.

27. The polarization grating stack of claim 26 wherein each stage in said polarization grating stack comprises a switchable half-wave plate followed by a single passive polarization grating.

28. A stack of polarization gratings, each having a grating pitch, the stack having a first end and a second end, and the polarization grating stack comprising:
a plurality of ternary stages, each of said ternary stages comprising at least one switchable half-wave plate and at least one active polarization grating wherein each stage provides a selectable deflection angle and wherein the stages are arranged in order of increasing deflection angle magnitude between the first end and the second end such that the stage with the largest deflection angle magnitude is nearest the second end of the polarization grating stack wherein:
one or more of said plurality of stages deflect an incident beam through angles lying substantially in a first plane and one or more of said stages deflect an incident beam through angles lying substantially in a second, different, plane lying at an angle relative to the first plane; and
at least some of said plurality of ternary stages are comprised in a first set, at least some are comprised in a second set, and wherein the first set deflects the incident beam through angles lying substantially in the first plane, the second set deflects an incident beam through angles lying substantially in a second plane lying at an angle with respect to the first plane, and wherein some stages in the first set are interleaved with at least some of the stages in the second set.

29. The polarization grating stack of claim 28 wherein each of the stages disposed to deflect the incident beam by angles lying substantially in the first plane is interleaved with the stages disposed to deflect the incident beam by angles lying substantially in the second plane.
